(19) United States
(12) Patent Application Publication
(10) Pub. No.: US 2004/0087687 A1
(43) Pub. Date: May 6, 2004

(54) Photocurable compositions with phosphite viscosity stabilizers

(75) Inventor: Darchun Billy Yang, San Dimas, CA (US)

Correspondence Address: PROSKAUER ROSE LLP, PATENT DEPARTMENT, 1585 BROADWAY, NEW YORK, NY, 10036-8299, US

(73) Assignee: Vantico A&T US Inc.

(21) Appl. No.: 10/283,233

(22) Filed: Oct. 30, 2002

(51) Int. Cl. C08L 63/00

(52) U.S. Cl. 523/451

(57) ABSTRACT

A photocurable composition, including (a) an epoxy resin component; (b) a (meth)acrylate; (c) a cationic photoinitiator; (d) a radical photoinitiator; and (e) a phosphite component. A method of making a 3-D object from such a composition, and the resulting 3-D object.

### BACKGROUND OF THE INVENTION

1. Field of the Invention

The invention relates to hybrid photocurable compositions containing alkyl, aryl or alkyl-aryl phosphite viscosity stabilizers, more particularly to such photocurable compositions for stereolithography, solid imaging and 3D printing applications.

2. Related Art

Phosphite esters, or “phosphites,” are tri-esters of phosphorus acid P(OH)₃ and one or more organic alcohols. Aryl, alkyl, mixed aryl alkyl, and phenol-containing phosphites have been used as stabilizers for thermoplastics such as polyvinyl chloride and polyalkylenes. U.S. Pat. No. 5,468,895; U.S. Pat. No. 4,806,580; U.S. Pat. No. 4,614,756; U.S. Pat. No. 4,333,868. Triaryl, trialkyl, and mixed aryl alkyl phosphite esters have been used as initiators or accelerators in the radical polymerization of (meth)acrylates. U.S. Pat. No. 4,563,438; U.S. Pat. No. 5,199,098; P.C. Adair, RadTech '94 N. Am. Conf. Exhib. Proc. (1994), Vol. 1, p. 564. Urethane acrylate compositions with triphenyl phosphite have been used for solder mask coatings. U.S. Pat. No. 4,614,704. Triphenyl phosphite has been used as a polymerization initiator for epoxide adhesives. G. Kaliske, Plaste U. Kautschuk 22, No. 4, April 1975, p. 338. Trimethyl phosphite has been disclosed as a possible co-initiator for cationic polymerization. R. Muneer et al., Macromolecules, Vol. 31, 7976 (1998).

Trimethyl phosphite has been disclosed as a scavenger of aryl radicals in a curable epoxy system using an aryl iodonium cationic initiator, but with no experimental details and no suggestion to use higher alkyl or aryl phosphite esters. R. S. Davidson, Polymers Paint Colour Journal 190, No. 4433 (October 2000), p. 26. At concentrations of over 2% tri-n-butyl phosphite can act as an oxygen scavenger. E. Zadok et al., Thermochimica Acta, 148 (1989) 387. Photocurable formulations containing ethylenically unsaturated monomers, a radical photoinitiator, and approximately 1% nonylated triphenylphosphite (as “stabilizer”) have been used for making flexographic printing plates. GB 2 179 360 A.

Commercial photocurable compositions for use in stereolithography are generally hybrids containing both epoxy and acrylate components that respectively polymerize by cationic and radical pathways. These formulations are therefore unpredictable in behavior compared to single-mechanism compositions. Stereolithography compositions are purchased in bulk quantities for use over an extended period of time. At times these compositions can cure prematurely during storage. This leads to an increase in the viscosity of the composition and eventually the composition may gel, or harden, and become unusable. Tertiary amine stabilizers such as benzyldimethylamine (“BDMA”) prevent premature curing, but in higher concentration may cause discoloration of the composition. Stabilizers such as BDMA can also act as an initiator for epoxy monomers through anionic polymerization mechanism if used at higher concentrations, which limits their use to only relatively low concentrations (i.e., at ppm level).

There is therefore a need for hybrid photocurable compositions that are storage stable for extended periods. In particular, there is a need for stereolithography compositions that have long viscosity stability but are not discolored by stabilizer additives.

### SUMMARY OF THE INVENTION

The invention provides a photocurable composition, including from 40 to 80% by weight of an epoxy resin component, from 5 to 40% by weight of a (meth)acrylate component, a cationic photoinitiator, a radical photoinitiator, and a phosphite ester that is an aliphatic, aromatic, or mixed aliphatic and aromatic phosphite ester, wherein the phosphite ester has the formula (I) or (II):

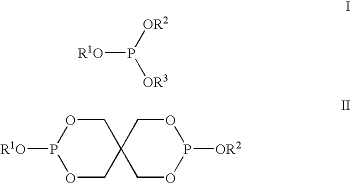

wherein R¹, R², and R³ are independently C4-C20 straight or branched alkyl, C4-C7 cycloalkyl, or phenyl, wherein the C4-C20 straight or branched alkyl is unsubstituted or substituted with one or more of C4-C7 cycloalkyl or phenyl, wherein the cycloalkyl and phenyl is unsubstituted or substituted with one or more of C1-C12 straight or branched alkyl.

The invention also provides a method of making a 3-D object from such a composition by forming a first layer of the photocurable composition; exposing the first layer to actinic radiation sufficient to harden the first layer; forming a second layer of the photocurable composition above the hardened first layer; exposing the second layer to actinic radiation sufficient to harden the second layer; and repeating the previous two steps as needed to form a 3-D object.

The invention also provides a 3-D object made by the method.

### BRIEF DESCRIPTION OF THE DRAWINGS

Features and details of the invention can be found in the illustrative embodiments of the invention which are described below with reference to the drawing, in which:

FIG. 1 is a chart showing the results of accelerated aging as viscosity over time for a formulation without phosphite stabilizer and formulations with phosphites Alkanox P24, Alkanox 240, and Alkanox TNPP, available from Great Lakes Chemical Corporation.

FIG. 2 is a bar chart showing percentage change in viscosity over time for the stabilizer formulations of FIG. 1.

FIG. 3 is a graph showing the results of accelerated aging as viscosity change over time for a formulation without phosphite stabilizer and formulations with phosphites Doverphos 6 (DP6) and Doverphos 8 (DP8), available from Dover Chemical Corporation, and Alkanox TNPP.

FIG. 4 is a graph showing accelerated aging as viscosity over time for formulations with different concentrations of phosphite stabilizer DP8.

FIG. 5 is a bar chart showing percentage change in viscosity over time for two stabilizer formulations of FIG. 4.

### DETAILED DESCRIPTION OF THE INVENTION

“Stereolithography” is a process that produces solid objects from computer-aided design (“CAD”) data. CAD data of an object is first generated and then is sliced into thin cross sections. A computer controls a laser beam that traces the pattern of a slice through a liquid photocurable composition, solidifying a thin layer of the composition corresponding to the slice. The solidified layer is recoated with liquid photocurable composition and the laser beam traces another slice to harden another layer of the composition on top of the previous one. The process continues layer by layer to complete the part. A desired part may be built in a matter of hours. This process is described in U.S. Pat. No. 5,476,748 to Steinmann et al., U.S. Patent Publication No. 2001/0046642 to Johnson et al., and by Jacobs in “Rapid Prototyping & Manufacturing” (Society of Manufacturing Engineers, 1992), the entire contents of which documents are incorporated herein by reference. Other similar applications include solid imaging and 3D printing technology. A solid imaging process is one wherein photocurable materials are also polymerized layer by layer in an imagewise fashion. Generally, the imaging region, that is the region exposed to actinic radiation, is required to harden to such an extent that can withstand disturbing forces such as shear force that may cause distortion or damage.

“3-D object” means a three-dimensional object made from at least two layers of a cured resin composition.

A “monomer” is a compound that is capable of polymerizing with other monomers to form a linear polymer chain or cross-linked polymer matrix. The term “monomer” refers to compounds with one or more reactive groups and includes oligomers that are, e.g., dimers or trimers formed from two or three monomer units, respectively.

“Polymerization” is a chemical reaction linking monomers to form larger molecules. The resulting polymers have units that correspond to the monomers.

“Curing” means to polymerize a mixture including one or more monomers and one or more initiators. “Hardening” may be synonymous with curing and emphasizes that when polymerized, liquid monomer mixtures tend to become solid.

“Photocurable composition” means a composition that may be cured or hardened by a polymerization reaction that is initiated by actinic radiation.

“Hybrid composition” means a photocurable composition with at least one radically curable component and at least one ionically (i.e., cation or anion) curable component.

“Cationically curable” means a monomer that can polymerize by cationic polymerization, a mechanism that involves cations, i.e., chemical species that are positively charged.

“Radically curable” means a monomer that can polymerize by radical polymerization, a mechanism that involves radicals, i.e., chemical species with an unpaired valence electron.

“Actinic radiation” is light energy at a wavelength that allows a given chemical compound to absorb the light energy and form a reactive species. For stereolithography, typically a laser beam or a flood lamp generates the actinic radiation.

“Photoinitiator” is a compound that absorbs actinic radiation to form a reactive species that initiates a chemical reaction such as polymerization. “Cationic photoinitiator” is a photoinitiator that generates cations when exposed to actinic radiation and thereby initiates cationic polymerization. “Radical photoinitiator” is a photoinitiator that generates radicals when exposed to actinic radiation and thereby initiates radical polymerization.

“(Meth)acrylate” refers to an acrylate, methacrylate, or a combination thereof.

“Green model” is the 3-D object initially formed by the stereolithography process of layering and curing, where typically the layers are not completely cured. This permits successive layers to better adhere by bonding together when further cured.

“Green strength” is a general term for mechanical performance properties of a green model, including modulus, strain, strength, hardness, and layer-to-layer adhesion. For example, green strength may be reported by measuring flexural modulus (ASTM D 790). An object having low green strength may deform under its own weight, or may sag or collapse during curing.

“Postcuring” is the process of reacting a green model to further cure the partially cured layers. A green model may be postcured by exposure to heat, actinic radiation, or both.

“Penetration depth” (“Dₚ”) is a property of a given pairing of photocurable composition and laser. Dₚ is the slope of a plot (“working curve”) of cure depth (mm) against the log of exposure (mJ/cm²). “Cure depth” is the measured thickness of a layer formed by exposing the photocurable composition to a specified dose of energy from the laser.

“Critical Exposure” (“Ec”) is a property of a photocurable composition and expresses the threshold amount of radiation in mJ/cm² that causes the photocurable composition to gel. The Eₘₐₓ is the maximum exposure value of the working curve when cure depth is still zero.

Unless indicated otherwise, percentages are by weight.

Cationically Curable Monomer (A)

Examples of cationically curable monomers are disclosed in, e.g., U.S. Pat. No. 5,476,748 and U.S. Patent Publication No. 2001/0046642 A1, both incorporated herein by reference.

The photocurable composition preferably contains from 40 to 80% by weight of cationically curable monomer, more preferably from 50 to 75% by weight.

The cationically curable monomer (a) may include one or more epoxide compounds in which the epoxide groups form part of an alicyclic or heterocyclic ring system. The alicyclic epoxide preferably includes at least one alicyclic polyepoxide having at least two epoxy groups per molecule. Preferably, the alicyclic polyepoxide is in a relatively pure form in terms of oligomer (e.g., dimer, trimer, etc.) content. Preferably, the alicyclic polyepoxide has a monomer purity of over about 90%, more preferably over about 94%, even more preferably 98% or higher. Ideally, dimers or trimers or higher oligomers are substantially eliminated. Preferably, the alicyclic polyepoxide has an epoxy equivalent weight from 80 and 330, more preferably from 90 and 300, even more preferably from 100 and 280.

Examples of alicyclic polyepoxides include bis(2,3-epoxycyclopentyl) ether, 2,3-epoxycyclopentyl glycidyl ether, 1,2-bis(2,3-epoxycyclopentyloxy)ethane, bis(4-hydroxycyclohexyl)methane diglycidyl ether, 2,2-bis(4-hydroxycyclohexyl)propane diglycidyl ether, 3,4-epoxycyclohexylmethyl 3,4-epoxycyclohexanecarboxylate, 3,4-epoxy-6-methylcyclohexylmethyl 3,4-epoxy-6-methylcyclohexanecarboxylate, di(3,4-epoxycyclohexylmethyl) hexanedioate, di(3,4-epoxy-6-methylcyclohexylmethyl) hexanedioate, ethylenebis(3,4-epoxycyclohexanecarboxylate, ethanediol di(3,4-epoxycyclohexylmethyl) ether, vinylcyclohexene dioxide, dicyclopentadiene diepoxide or 2-(3,4-epoxycyclohexyl-5,5-spiro-3,4-epoxy)cyclohexane-1,3-dioxane.

3,4-epoxycyclohexylmethyl 3′,4′-epoxycyclohexanecarboxylate having an epoxy equivalent weight from 130 and 145 with varying degrees of monomer purity are commercially available. Araldite CY179 of Ciba Specialty Chemicals has monomer purity of about 90%. UVR6105 of DOW Corp. contains a smaller percentage of oligomers and thus has higher monomer purity than Araldite CY 179. Preferred is Uvacure 1500 of UCB Radcure Corp., which has monomer purity of about 98.5%.

The photocurable composition preferably contains from 5 to 80% by weight, more preferably from 10 and 75% by weight, even more preferably from 15 to 70% by weight of alicyclic polyepoxide.

The photocurable composition preferably includes one or more cationically curable compounds that are polyglycidyl ethers, poly(β-methylglycidyl) ethers, polyglycidyl esters, poly(β-methylglycidyl) esters, poly(N-glycidyl) compounds, and poly(S-glycidyl) compounds. Cationically curable oxetanes are disclosed in U.S. Pat. No. 5,463,084, incorporated herein by reference.

Polyglycidyl ethers can be obtained by reacting a compound having at least two free alcoholic hydroxyl groups and/or phenolic hydroxyl groups with a suitably substituted epichlorohydrin under alkaline conditions or in the presence of an acidic catalyst followed by alkali treatment. Ethers of this type may be derived, for example, from acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins. Suitable glycidyl ethers can also be obtained from cycloaliphatic alcohols such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or aromatic alcohols such as N,N-bis(2-hydroxyethyl)aniline or p,p′-bis(2-hydroxyethylamino)diphenylmethane.

Examples of preferred polyglycidyl ethers include trimethylolpropane triglycidyl ether, triglycidyl ether of polypropoxylated glycerol, and diglycidyl ether of 1,4-cyclohexanedimethanol.

The following are examples of commercially available cationically curable monomers: Uvacure 1500, Uvacure 1501, Uvacure 1502 (1501 and 1502 have been discontinued by UCB), Uvacure 1530, Uvacure 1531, Uvacure 1532, Uvacure 1533, Uvacure 1534, Uvacure 1561, Uvacure 1562, all commercial products of UCB Radcure Corp., Smyrna, GA; UVR-6100, UVR-6105, UVR-6110, UVR-6128, UVR-6200, UVR-6216 of DOW Corp.; the Araldite GY series that is Bisphenol A epoxy liquid resins, the Araldite CT and GT series that is Bisphenol A epoxy solid resins, the Araldite GY and PY series that is Bisphenol F epoxy liquids, the cycloaliphatic epoxides Araldite CY 179 and PY 284, the Araldite DY and RD reactive diluents series, the Araldite ECN series of epoxy cresol novolacs, the Araldite EPN series of epoxy phenol novolacs, all commercial products of Ciba Specialty Chemicals Corp., the Heloxy 44, Heloxy 48, Heloxy 84, Heloxy 107, and others in the Heloxy product line, the EPON product line, all of Resolution Performance Products (Houston, Tex.), the DER series of flexible aliphatic and Bisphenol A liquid or solid epoxy resins, the DEN series of epoxy novolac resins, all commercial products of Dow Corp.; Celoxide 2021, Celoxide 2021P, Celoxide 2081, Celoxide 2083, Celoxide 2085, Celoxide 2000, Celoxide 3000, Glycidole, AOEX-24, Cyclomer A200, Cyclomer M-100, Epolead GT-300, Epolead GT-302, Epolead GT-400, Epolead 401, Epolead 403, (Daicel Chemical Industries Co., Ltd.), Epicoat 828, Epicoat 812, Epicoat 872, Epicoat CT 508 (Yuka Shell Co., Ltd.), KRM-2100, KRM-2110, KRM-2199, KRM-2400, KRM-2410, KRM-2408, KRM-2490, KRM-2200, KRM-2720, KRM-2750 (Asahi Denka Kogyo Co., Ltd.).

In addition, liquid pre-reacted adducts of such epoxy resins with hardeners are suitable for use as component (A).

Cationically curable cyclic compounds other than epoxies which may be used in the compositions of the invention include oxetanes, oxolanes, cyclic acetals, anhydrides, cyclic lactones, thiuranes, and thiotanes. Typical oxetane compounds include trimethylene oxide, 3,3-dimethyloxetane and 3,3-dichloromethyloxetane, 3-ethyl-3-phenoxymethyloxetane, and bis(3-ethyl-3-methyloxy)butane. Typical oxolane compounds include tetrahydrofuran and 2,3-dimethyl-tetrahydrofuran. Typical cyclic acetal compounds include trioxane, 1,3-dioxalane and 1,3,6-trioxan cycloctane. Typical cyclic lactone compounds include β-propiolactone and ε-caprolactone. Typical anhydrides include phthalic anhydride and terephthalic anhydride and hydroxy-containing derivatives thereof. Typical thiirane compounds include ethylene sulphide, 1,2-propylene sulphide and thioepichlorohydrin. Typical thiotane compounds include 1,3-propylene sulphide and 3,3-dimethylthiothane.

The cationically curable monomer may include compounds containing vinyl ether groups. Preferred examples are aliphatic polyalkoxy di(poly)vinylethers, polyalkylene di(poly)vinylethers, and hydroxy-functionalized mono(poly)vinylethers. More preferred vinylethers are those having aromatic or alicyclic moieties in their molecules. Preferably, the vinylether component is from 0.5 to 20% by weight of the photocurable composition. More preferably the vinylether component is from 2 to 17% by weight. Even more preferably, the vinyl ether component is from 3 to 14% by weight.

Examples of vinyl ethers include ethyl vinylether, n-propyl vinylether, isopropyl vinylether, n-butyl vinylether, isobutyl vinylether, octadecyl vinylether, cyclohexyl vinylether, butanediol divinylether, cyclohexanedimethanol divinylether, diethyleneglycol divinylether, triethyleneglycol divinylether, tert-butyl vinylether, tert-amyl vinylether, ethylhexyl vinylether, dodecyl vinylether, ethyleneglycol divinylether, ethyleneglycolbutyl vinylether, hexanediol divinylether, triethyleneglycol methylvinylether, tetraethyleneglycol divinylether, trimethylolpropane trivinylether, aminopropyl vinylether, diethylaminoethyl vinylether, ethylene glycol divinyl ether, polyalkylene glycol divinyl ether, alkyl vinyl ether and 3,4-dihydropyran-2-methyl 3,4-dihydropyran-2-carboxylate. Examples of commercial vinyl ethers include the Pluriol-E200 divinyl ether (PEG200-DVE), poly-THF290 divinylether (PTHF290-DVE) and polyethyleneglycol-520 methyl vinylether (MPEG500-VE) all of BASF Corp.

Examples of hydroxy-functionalized mono(poly)vinylethers include polyalkyleneglycol monovinylethers, polyalkylene alcohol-terminated polyvinylethers, butanediol monovinylether, cyclohexanedimethanol monovinylether, ethyleneglycol monovinylether, hexanediol monovinylether, and diethyleneglycol monovinylether.

Further examples of vinyl ethers are disclosed in U.S. Pat. No. 5,506,087, incorporated herein by reference.

Examples of commercial vinyl ethers include Vectomer 4010 (HBVE isophthalate), Vectomer 4020 (pentanedioic acid, bis[[4-[(ethenyloxy)methyl]cyclohexyl]methyl] ester), Vectomer 4051 (CHMVE terephthalate), Vectomer 4060 (vinyl ether terminated aliphatic ester monomer: HBVE adipate), and Vectomer 5015 (tris(4-vinyloxybutyl)trimellitate), all of Morflex, Inc., Greensboro, N.C. Preferred vinyl ethers are Vectomer 4010 and Vectomer 5015.

The photocurable composition of the invention may include mixtures of the cationically curable compounds described above.

Radically Curable Monomer (B)

The radically curable monomer (b) of the invention is preferably ethylenically unsaturated. More preferably, the monomer is a (meth)acrylate. The monomer may include at least one poly(meth)acrylate, e.g., a di-, tri-, tetra- or pentafunctional monomeric or oligomeric aliphatic, cycloaliphatic, or aromatic (meth)acrylate. The poly(meth)acrylate preferably has a molecular weight of from 200 to 500.

Examples of di(meth)acrylates include di(meth)acrylates of cycloaliphatic or aromatic diols such as 1,4-dihydroxymethylcyclohexane, 2,2-bis(4-hydroxy-cyclohexyl)propane, bis(4-hydroxycyclohexyl)methane, hydroquinone, 4,4′-dihydroxybiphenyl, Bisphenol A, Bisphenol F, bisphenol S, ethoxylated or propoxylated Bisphenol A, ethoxylated or propoxylated Bisphenol F, and ethoxylated or propoxylated bisphenol S. Di(meth)acrylates of this kind are known and some are commercially available.

Alternatively, the di(meth)acrylate may be acyclic aliphatic, rather than cycloaliphatic or aromatic.

Preferably, the poly(meth)acrylate includes a tri(meth)acrylate or higher. Preferred compositions are those in which the free radically curable component contains a tri(meth)acrylate or a penta(meth)acrylate. Examples are the tri(meth)acrylates of hexane-2,4,6-triol, glycerol, 1,1,1-trimethylolpropane, ethoxylated or propoxylated glycerol, and ethoxylated or propoxylated 1,1,1-trimethylolpropane. Other examples are the hydroxyl-containing tri(meth)acrylates obtained by reacting triepoxide compounds (e.g., the triglycidyl ethers of the triols listed above) with (meth)acrylic acid. Other examples are pentaerythritol tetraacrylate, bistrimethylolpropane tetraacrylate, pentaerythritol monohydroxytri(meth)acrylate, or dipentacrythritol monohydroxypenta(meth)acrylate. The poly(meth)acrylate may include polyfunctional urethane (meth)acrylates. Urethane (meth)acrylates can be prepared by, e.g., reacting a hydroxyl-terminated polyurethane with acrylic acid or methacrylic acid, or by reacting an isocyanate-terminated prepolymer with hydroxyalkyl (meth)acrylates to give the urethane (meth)acrylate.

Examples of suitable aromatic tri(meth)acrylates are the reaction products of triglycidyl ethers of trihydric phenols and phenol or cresol novolaks containing three hydroxyl groups, with (meth)acrylic acid.

The following are examples of commercial poly(meth)acrylates: SR® 295, SR® 350, SR® 351, SR® 367, SR® 368, SR® 399, SR® 444, SR® 454, and SR® 9041 (SARTOMER Company).

SR® 368 is an example of an isocyanurate triacrylate, which is preferably included in the photocurable composition with a smaller amount of a monohydroxypentaacrylate such as SR® 399 to avoid producing tacky sidewalls in the 3-D object.

Additional examples of commercially available acrylates include KAYARAD R-526, HDDA, NPGDA, TPGDA, MANDA, R-551, R-712, R-604, R-684, PET-30, GPO-303, TMPTA, THE-330, DPHA-2H, DPHA-2C, DPHA-21, D-310, D-330, DPCA-20, DPCA-30, DPCA-60, DPCA-120, DN-0075, DN-2475, T-1420, T-2020, T-2040, TPA-320, TPA-330, RP-1040, R-011, R-300, R-205 (Nippon Kayaku Co., Ltd.), Aronix M-210, M-220, M-233, M-240, M-215, M-305, M-309, M-310, M-315, M-325, M-400, M-6200, M-6400 (Toagosei Chemical Industry Co, Ltd.), Light acrylate BP-4EA, BP-4PA, BP-2EA, BP-2PA, DCP-A (Kyoeisha Chemical Industry Co., Ltd.), New Frontier BPE-4, TEICA, BR-42M, GX-8345 (Daichi Kogyo Seiyaku Co., Ltd.), ASF-400 (Nippon Steel Chemical Co.), Ripoxy SP-1506, SP-1507, SP-1509, VR-77, SP-4010, SP-4060 (Showa Highpolymer Co., Ltd.), NK Ester A-BPE-4 (Shin-Nakamura Chemical Industry Co., Ltd.), SA-1002 (Mitsubishi Chemical Co., Ltd.), Viscoat-195, Viscoat-230, Viscoat-260, Viscoat-310, Viscoat-214HP, Viscoat-295, Viscoat-300, Viscoat-360, Viscoat-GPT, Viscoat-400, Viscoat-700, Viscoat-540, Viscoat-3000, Viscoat-3700 (Osaka Organic Chemical Industry Co., Ltd.).

Preferably, the radically curable monomer includes a compound having at least one terminal and/or at least one pendant (i.e., internal) unsaturated group and at least one terminal and/or at least one pendant hydroxyl group. The composition may contain more than one such compound. Examples of such compounds include hydroxy mono(meth)acrylates, hydroxy poly(meth)acrylates, hydroxy monovinylethers, and hydroxy polyvinylethers. Commercially available examples include dipentyaerythritol pentaacrylate (SR® 399), pentaerythritol triacrylate (SR® 444), and bisphenol A diglycidyl ether diacrylate (Ebecryl 3700).

The photocurable composition preferably contains up to 60%, more preferably from 5 to 20%, even more preferably from 9 to 15% of radically curable monomer(s).

In one embodiment, the photocurable composition contains up to 40% by weight, more preferably from 5 to 20% by weight, of a cycloaliphatic or aromatic di(meth)acrylate and up to 15% by weight, preferably up to 10% by weight of a poly(meth)acrylate with 3 or more (meth)acrylate groups. The ratio of diacrylate to poly(meth)acrylate with 3 or more (meth)acrylate groups may vary, but preferably the latter is no more than 50% of total (meth)acrylates.

In another embodiment, the photocurable composition may contain much smaller relative amounts of di(meth)acrylate, and may even contain exclusively poly(meth)acrylates with 3 or more (meth)acrylate groups as radically curable monomer (b) with no or substantially no di(meth)acrylate.

The photocurable composition of the invention may include mixtures of the radically curable compounds described above.

Photoinitiators

Cationic photoinitiators (c) may be chosen from those commonly used to initiate cationic photopolymerization. Examples include onium salts with anions of weak nucleophilicity, e.g., halonium salts, iodosyl salts, sulfonium salts, sulfoxonium salts, or diazonium salts. Metallocene salts are also suitable as photoinitiators. Onium salt and metallocene salt photoinitiators are described in U.S. Pat. No. 3,708,296; EP 153904 A; EP 35969 A; EP 44272 A; EP 54509 A; EP 164314 A; “UV-Curing, Science and Technology”, (Editor: S. P. Pappas, Technology Marketing Corp., Stamford, Conn.); and “Chemistry & Technology of UV & EB Formulations for Coatings, Inks & Paints,” Vol. 3 (edited by P. K. T. Oldring), each of which is incorporated herein by reference.

Examples of commercial cationic photoinitiators include UVI-6974, UVI-6976, UVI-6970, UVI-6960, UVI-6990 (manufactured by DOW Corp.), CD-010, CD-1011, CD-1012 (manufactured by Sartomer Corp.), Adekaoptomer SP-150, SP-151, SP-170, SP-171 (manufactured by Asahi Denka Kogyo Co., Ltd.), Irgacure 261 (Ciba Specialty Chemicals Corp.), CI-2481, CI-2624, CI-2639, CI-2064 (Nippon Soda Co, Ltd.), DTS-102, DTS-103, NAT-103, NDS-103, TPS-103, MDS-103, MPI-103, BBI-103 (Midori Chemical Co, Ltd.). Most preferred are UVI-6974, CD-1010, UVI-6976, Adekaoptomer SP-170, SP-171, CD-1012, and MPI-103. The cationic photoinitiators can be used either individually or in combination of two or more. The cationic photoinitator is preferably present at from 0.05 to 12% by weight, more preferably from 0.1 to 11% by weight, most preferably from 0.15 to 10% by weight of the photocurable composition.

For stereolithography using a laser, the radical and cationic photoinitiators are preferably selected and their concentrations are preferably adjusted to achieve an absorption capacity such that the depth of cure at the normal laser rate is from about 0.1 to about 2.5 mm.

Radical photoinitiator (d) may be chosen from those commonly used to initiate radical photopolymerization. Examples of radical photoinitiators include benzoins, e.g., benzoin, benzoin ethers such as benzoin methyl ether, benzoin ethyl ether, benzoin isopropyl ether, benzoin phenyl ether, and benzoin acetate; acetophenones, e.g., acetophenone, 2,2-dimethoxyacetophenone, and 1,1-dichloroacetophenone; benzil and benzil ketals, e.g., benzil dimethylketal and benzil diethyl ketal; anthraquinones, e.g., 2-methylanthraquinone, 2-ethylanthraquinone, 2-tert-butylanthraquinone, 1-chloroanthraquinone and 2-amylanthraquinone; triphenylphosphine; benzoylphosphine oxides, e.g., 2,4,6-trimethylbenzoyl-diphenylphosphine oxide (Luzirin® TPO); bisacylphosphine oxides; benzophenones, e.g., benzophenone and 4,4′-bis(N,N′-di-methyl-amino)benzophenone; thioxanthones and xanthones; acridine derivatives; phenazine derivatives; quinoxaline derivatives; 1-phenyl-1,2-propanedione 2-O-benzoyl oxime; 4-(2-hydroxyethoxy)phenyl-(2-propyl)ketone (Irgacure 2959; Ciba Specialty Chemicals); 1-aminophenyl ketones or 1-hydroxy phenyl ketones, e.g., 1-hydroxycyclohexyl phenyl ketone, 2-hydroxyisopropyl phenyl ketone, phenyl 1-hydroxyisopropyl ketone, and 4-isopropylphenyl 1-hydroxyisopropyl ketone.

Preferably, the photocurable composition includes a 1-hydroxy phenyl ketone, more preferably 1-hydroxycyclohexyl phenyl ketone, e.g., Irgacure 184 (Ciba Specialty Chemicals).

The radical photoinitator is preferably present at from 0.1 to 10% by weight, more preferably from 0.3 to 8% by weight, most preferably from 0.4 to 7% by weight of the photocurable composition.

Phosphite (E)

The composition preferably contains a component (e) that is one or more phosphite ester stabilizers. Component (e) is preferably 0.005-10% by weight of a phosphite ester that is an aliphatic, aromatic, or mixed aliphatic and aromatic phosphite ester, wherein the phosphite ester has the formula (I) or (II):

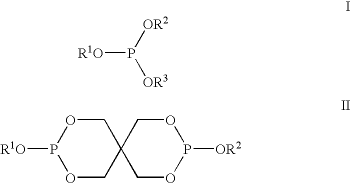

wherein R1, R2, and R3 are independently C4-C20 straight or branched alkyl, C4-C7 cycloalkyl, or phenyl,

wherein the C4-C20 straight or branched alkyl is unsubstituted or substituted with one or more of C4-C7 cycloalkyl or phenyl,

wherein the cycloalkyl and phenyl is unsubstituted or substituted with one or more of C1-C12 straight or branched alkyl.

The phosphite stabilizers described herein are readily available from commercial sources. For example, preferred phosphites Doverphos 6 (“DP6”) and Doverphos 8 (“DP8”) are available from Dover Chemical Corporation (Dover, Ohio), and Alkanox TNPP (“tris-nonylphenyl phosphite”), Alkanox 240, and Alkanox P24 are available from Great Lakes Chemical Corporation (West Lafayette, Ind.).

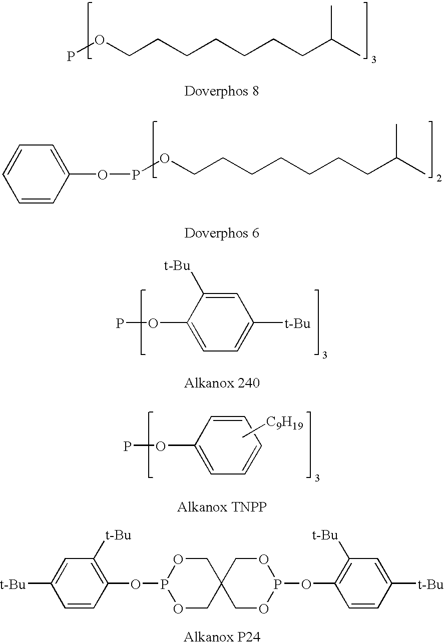

The phosphite stabilizers preferably contain no heteroatoms other than the oxygen atoms bonded to phosphorus, and no unsaturated alkyl or cycloalkyl groups.

The photocurable composition preferably contains from 0.005 to 10% by weight of component (e), more preferably from 0.2 to 1.5%, even more preferably from 0.4 to 0.7%.

The resulting composition is preferably storage stable for at least 6 months, more preferably for at least one year. The composition, when subjected to accelerated aging at 65° C., will preferably not gel before 12 days, more preferably not before one month.

Other Components

The photocurable composition may contain a variety of other components. Examples of such components include modifiers, tougheners, stabilizers, antifoaming agents, leveling agents, thickening agents, flame retardants, antioxidants, pigments, dyes, fillers, and combinations thereof.

The compositions according to the invention may also advantageously contain hydroxy compounds, e.g., as described in U.S. Pat. No. 6,379,866, U.S. Pat. No. 5,629,133, and U.S. Pat. No. 5,972,563. These may be hydroxy terminated polyethers, such as polytetrahydrofuran (“poly THF”) diols and polyols, e.g., polytetramethylene ether glycols, having a molecular weight of about 250 to about 4000, or siloxane/polyethylene oxide copolymers. These may be terminated with hydroxy, epoxy, or ethylenically unsaturated group(s). Polytetramethylene ether glycols are commercially available in the Polymeg® line (Penn Specialty Chemicals), e.g., Polymeg® 1000 or Polymeg® 2000.

The photocurable composition may also contain one or more diols such as 1,4-cyclohexanedimethanol (“CHDM”).

The photocurable composition may also contain one or more stabilizers. Preferred stabilizers are hindered amines, e.g., benzyl dimethyl amine (“BDMA”). The composition preferably contains from 50 to 300 ppm of a hindered amine such as BDMA, more preferably not more than 400 ppm. Hindered amine stabilizers can also act as initiators, and if used in too high a concentration can destabilize the composition by prematurely initiating polymerization.

The compositions of the present invention can be readily prepared by, for example, premixing individual components and then mixing these premixes, or by mixing all of the components using customary devices, such as stirred vessels. The compositions are preferably prepared in the absence of light and, if necessary, at slightly above room temperature. Preferably, the composition is a liquid.

Stereolithography Equipment

The actinic radiation is generally a beam of light that is controlled by a computer. Preferably, the beam is a laser beam controlled by a mirror.

In principle any stereolithography machine may be used to carry out the inventive method. Stereolithography equipment is commercially available from various manufacturers. Table I lists commercial SL equipment available from 3D Systems, Inc. (Valencia, Calif.).

TABLE I
Stereolithography Machines

| Machine | Layer Type | Wavelength (nm) |
|---|---|---|
| SLA 250 | Helium Cadmium, | 325 |
| | 20 mW at vat | |
| Viper Si2 SLA | Solid state Nd:YVO₄, | 354.7 |
| | 100 mW at vat | |
| SLA 3500 | Solid state ND:YVO₄, | 354.7 |
| | 160 mW at Vat | |
| SLA 500 | Argon ion, 65 mW at | 351,364 |
| | vat | |
| SLA 5000 | Solid state Frequency | 354.7 |
| | Tripled Nd:YVO₄, 216 | |
| | mW at vat | |
| SLA 7000 | Solid state Frequency | 354.7 |
| | Tripled Nd:YVO₄, 800 | |
| | mW at vat | |

### EXAMPLES

Preparation of 3-D Objects

The general procedure used for preparing 3-D objects with SL equipment is as follows. A SLA 7000 machine is used for all the 3-D part building. The exposures were made using a solid state frequency tripled Nd:YVO₄ laser with a wavelength of 354.7 nm and 800 mW power output at vat. The beam was scanned in a parallel line scan with each line approximately 0.002 inches apart.

In each of the examples, a green model was prepared using the manufacturer's recommended default settings for Dₚ and E_{c}. The photocurable composition was placed in a 300-700 ml plastic container or in a vat designed for use with the stereolithography machines. The specific container depends on the size of the desired 3-D object. The photocurable composition was poured into the container within the machine at about 30° C. The surface of the composition, in its entirety or a predetermined pattern, was irradiated with a 354.7 nm light source so that a layer of a desired thickness cured and solidified in the irradiated area. A new layer of the photocurable composition was formed on the solidified layer. The new layer was likewise irradiated over the entire surface or in a predetermined pattern. The newly solidified layer adhered to the underlying solidified layer. Repeating the layer formation step and the irradiation step produced a green model of multiple solidified layers. After the building process was completed, the green model was then rinsed in tripropylene glycol monomethyl ether (“TPM”). The green model was then rinsed with water and dried with compressed air. The dried green model was then postcured with UV radiation in a postcure apparatus (“PCA”) for about 60 to 90 minutes. The dimension of green model was measured with a digital caliper. The green model used for flexural modulus (GFM) measurement was a test strip with a dimension of approximately 2.8 mm×6.3 mm and 70.5 mm. The Flexural Modulus was measured using a United STM ‘Smart-1 ’ Test System (model SSTM-1 by United Calibration Corporation, Huntington Beach, Calif.) equipped with a 20 pounds loadcell.

3-D objects made using the photocurable composition are preferably colorless and either water-clear, opaque, or colored with a dye.

Stereolithography equipment typically allows for setting various operational parameters. The parameters are well known to a person of skill in the art of stereolithography and may be adjusted as needed depending on various factors, including the specific photocurable composition and the geometry of the desired 3-D object.

Base Resin

The base resin used in the examples had the composition shown in Table II. The base resin alone with no phosphite stabilizer served as comparative example.

TABLE II
Base Resin Composition

| Name (Source) | Description | Weight (g) |
|---|---|---|
| HELOXY 48 | Trimethylolpropane triglycidyl ether | 30.0 |
| (Resolution Performance Products LLC) | | |
| UVACURE 1500 | 3,4-Epoxycyclohexylmethyl 3′,4′- | 50.2 |
| (UCB Chemicals Corp./Radcure) | epoxycyclohexanecarboxylate | |
| Cyracure UVI-6976 | Mixture of PhS—(C₆H₄)—S⁺Ph₂ SbF₆⁻ and | 5.00 |
| (Dow Chemical Company) | Ph₂S⁺—(C₆H₄)S(C₆H₄)—S⁺Ph₂ (SbF₆⁻)₂ | |
| SR 399 | Dipentaerythritol pentaacrylate | 6.00 |
| (Sartomer Co.) | | |
| Ebecryl 3700 | Bisphenol A diglycidyl ether diacrylate [4687- | 6.30 |
| (Radcure Specialties) | 94-9] | |
| Irgacure 184 | 1-hydroxycyclohexyl phenyl ketone | 2.50 |
| (Ciba Specialty Chemicals) | | |
| BDMA | Benzyl dimethyl amine | 0.03 |

### Examples 1-13

### Accelerated Aging Test

A standard accelerated aging test at 65° C. was used to evaluate resin stability. Premature polymerization during storage due to resin instability leads to a viscosity increase. Resin instability was tested by measuring viscosity change over time. Viscosity was measured by using a Brookfield DVIII viscometer equipped with a spindle #27 at 25° C.

Since the thermal decomposition of the photoinitiator is a kinetically controlled reaction, the Arrhenius Theory can be used to predict the decomposition rate. The temperature dependency of a particular formulation is related to its activation energy. Generally, a 10° C. increase in temperature doubles the reaction rate. The viscosity stability of a sample stored at 65° C. for one month is thus comparable to a sample stored for well over one year at room temperature (ca. 25° C.).

Tables III-V show results of the Accelerated Aging Test. Comparative Examples 1, 7, and 11 and Examples 2-6,8-10, and 12-13 were prepared by combining the components shown in Tables III-V at room temperature in a container to form a homogeneous mixture. In Example 3, Alkanox 240 did not dissolve completely.

TABLE III

| | | | | | |
|---|---|---|---|---|---|
| Comp. | | | | | |
| Example 1 | Example 2 | Example 3 | Example 4 | Example 5 | Example 6 |

FORMULATION

| Component | Weight % | | | | | |
|---|---|---|---|---|---|---|
| Base resin (%) | 100.000 | 99.396 | 99.353 | 99.311 | 99.700 | 99.993 |
| Alkanox P24 (%) | | 0.604 | | | | |
| Alkanox 240 (%) | | | 0.647 | | | |
| Alkanox TNPP (%) | | | | 0.689 | 0.300 | 0.007 |
| Stabilizer molar | 0 | 0.0100 | 0.0100 | 0.0100 | 0.0040 | 0.0001 |
| concentration | | | | | | |

AGING AT 65° C.

| No. of days | Viscosity (cps, 25° C.) | | | | | |
|---|---|---|---|---|---|---|
| 0 days | 315 | 269 | 263 | 287 | 268 | 266 |
| 7 days | gelled | 283 | 276 | 294 | 282 | 278 |
| 14 days | | 282 | 278 | 293 | 285 | 286 |
| 21 days | | 287 | 284 | 296 | 287 | 300 |
| 28 days | | 294 | 295 | 306 | 297 | 308 |
| 35 days | | 302 | 300 | 307 | 300 | 330 |
| 42 days | | 311 | 303 | 315 | 307 | 350 |

TABLE IV

| | | | |
|---|---|---|---|
| Comp. | | | |
| Example 7 | Example 8 | Example 9 | Example 10 |

FORMULATION

| | | | | |
|---|---|---|---|---|
| Component | | | | |
| Base resin (g) | 100.00 | 230.00 | 230.00 | 230.00 |
| Doverphos 6 (g) | | 0.860 | | |
| Doverphos 8 (g) | | | 1.157 | |
| Alkanox TNPP (g) | | | | 1.584 |
| Stabilizer molar | 0 | 0.01 | 0.01 | 0.01 |
| concentration | | | | |
| Stabilizer wt. % | 0 | 0.373 | 0.503 | 0.689 |

AGING AT 65° C.

| No. of days | Viscosity (cps, 25° C.) | | | |
|---|---|---|---|---|
| 0 days | 318 | 308 | 307 | 318 |
| 7 days | gelled | 1033 | 307 | 327 |
| 16 days | | gelled | 313 | 328 |
| 24 days | | | 316 | 335 |
| 42 days | | | 330 | 342 |
| 48 days | | | 333 | 345 |

TABLE V

| | | |
|---|---|---|
| Comp. | | |
| Example 11 | Example 12 | Example 13 |

FORMULATION

| Component | Weight % | | |
|---|---|---|---|
| Base resin | 100.000 | 99.396 | 99.900 |
| Doverphos 8 | 0 | 0.100 | 0.050 |

AGING AT 65° C.

| No. of days | Viscosity (cps, 25° C.) | | |
|---|---|---|---|
| 0 days | 315 | 271 | 271 |
| 7 days | gelled | 275 | 279 |
| 14 days | | 285 | 290 |
| 21 days | | 287 | 293 |
| 28 days | | 300 | 328 |
| 35 days | | 318 | Gelled |
| 42 days | | 345 | |

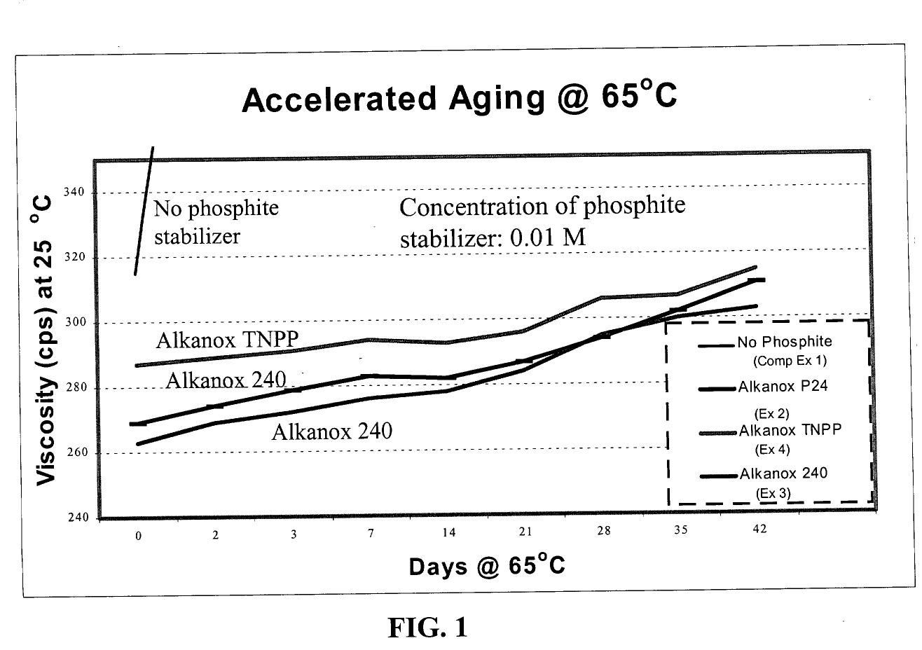

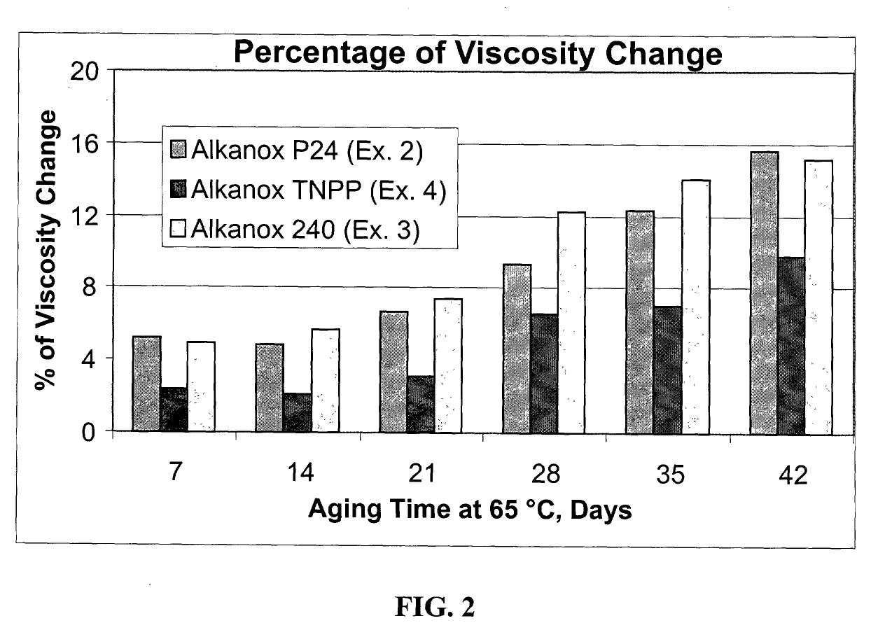

Data in Tables III-V is presented in FIGS. 1-5. FIG. 1 is a chart showing the results of accelerated aging as viscosity over time for Comparative Example 1 (no phosphite stabilizer), Example 2 (Alkanox P24), Example 3 (Akalnox 240), and Example 4 (Alkanox TNPP). Despite containing BDMA stabilizer, Comparative Example 1 without phosphite stabilizer gelled within one week of aging time at 65° C. FIG. 2 is a bar chart showing a moderate percentage change in viscosity over time for Examples 2-4 during the accelerated aging test.

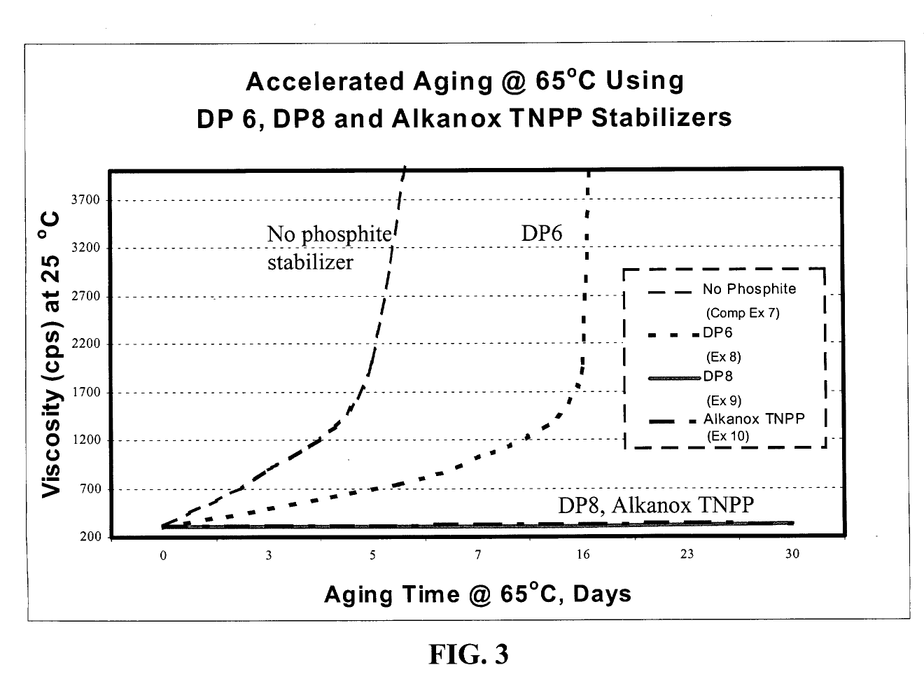

FIG. 3 is a graph showing accelerated aging as viscosity over time for Comparative Example 7 (no phosphite stabilizer), Example 8 (DP6), Example 9 (DP8), and Example 10 (Alkanox TNPP). Comparative Example 7, containing BDMA but no phosphite, gelled within one week of aging time at 65° C.

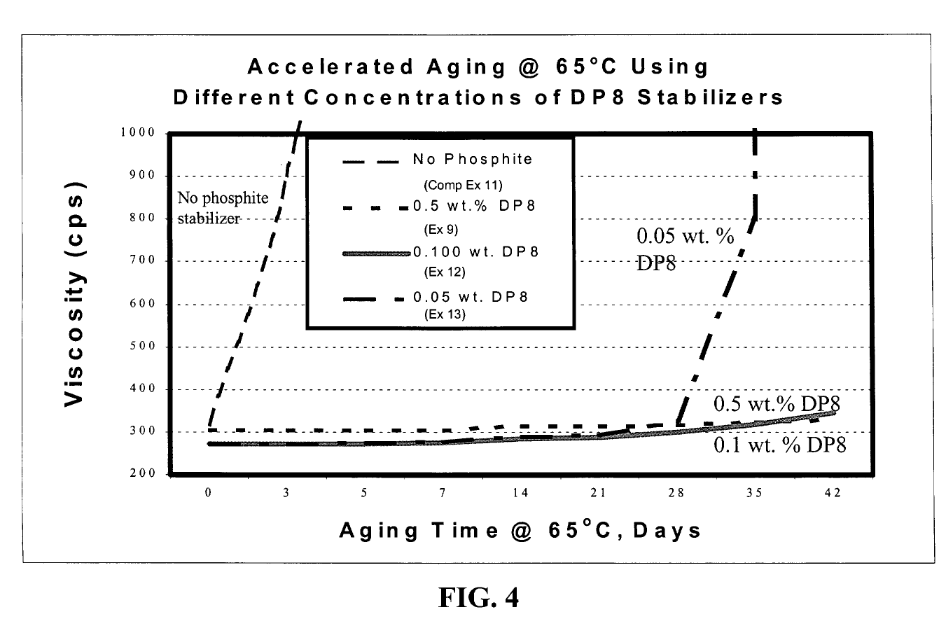

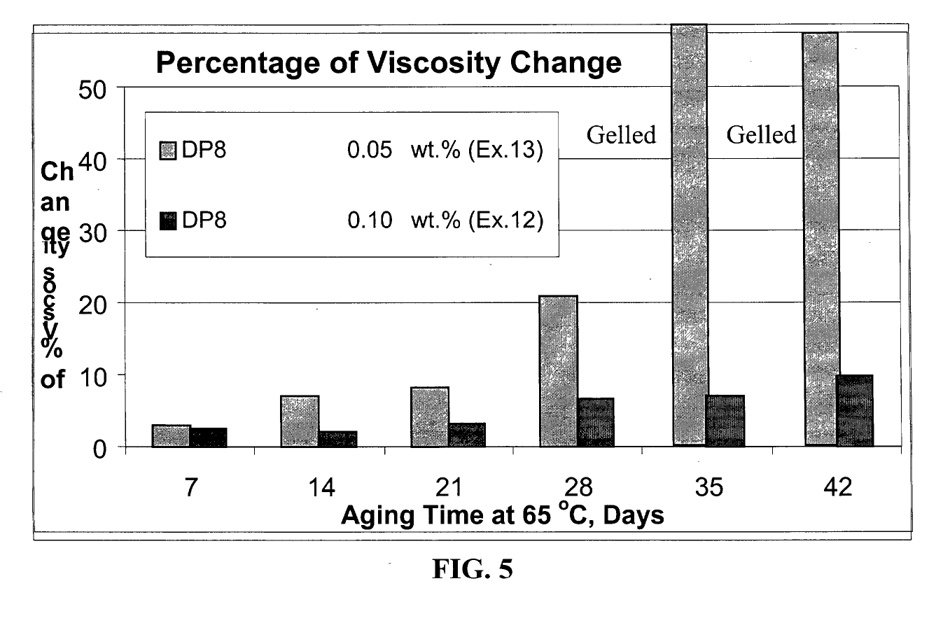

FIG. 4 is a graph showing accelerated aging as viscosity over time for Comparative Example 11 (no phosphite stabilizer), Example 12 (0.10% DP8), and Example 13 (0.050% DP8), which contain different concentrations of phosphite stabilizer DP8. As before, the comparative example with no phosphite gelled within one week of aging time at 65° C. FIG. 5 is a bar chart showing the percentage change in viscosity over time for Example 12 (0.10% DP8) and Example 13 (0.050% DP8). The formulation with 0.050% DP8 gelled after 35 days, which corresponds to over one year at room temperature. The formulation with 0.10% DP8 did not gel even after 42 days, i.e., well over one year.

### Examples 14-15

### Mechanical Strength Data

3-D objects were prepared by stereolithography using the formulation of Example 3 without phosphite stabilizer (Example 14) and using the formulation of Example 4 with 0.689 wt. % of Alkanox TNPP (Example 15).

Table VI shows mechanical properties of these 3-D objects.

TABLE VI

| | Example 14 | Example 15 |
|---|---|---|
| | (no phosphites) | (Alkanox TNPP) |
| SLA/Max power (mW) | 7000/650 | 7000/650 |
| Build with Dₚ/E_{c} | 5.7-6.0/8.5-11.6 | 5.7-6.0/8.5-11.6 |
| Dₚ (mils)* | 6.29 | 4.77 |
| E_{c} (mJ/cm²)* | 7.97 | 2.67 |
| CD4* | 5.46 | 9.36 |
| CD11* | 13.32 | 15.31 |
| 10 minutes, GFM (mPa) | 35 | 31 |
| 60 minutes, GFM (mPa) | 194 | 157 |
| UV Postcured Tensile | 8600 | |
| Strength, psi | | 3328 |
| UV Posteured Tensile | 438 | |
| Modulus, ksi | | 131 |
| UV post cured Elongation | 4.5 | 6.2 |
| at break, % | | |

*Calculated values based on the WP measurements

In Table VI, “WP” is windowpane data, “GFM” is green flexural modulus, “CD4” is critical energy for 4 mil cure depth, and “CD11” is critical energy for 11 mil cure depth. The properties labeled “UV Postcured” are measured on 3-D objects given a 90 minute flood exposure in 3D Systems' Post Cure Apparatus. The 10 minutes/60 minutes GFM are 31/157 mPa and 35/194 mPa for parts built with and without Alkanox TNPP, respectively. However, the presence of phosphite ester improves the required critical energy exposure (E_{c}, mJ/cm²). Thus, Dₚ is comparable in Example 15 with Alkanox TNPP and Example 14 with no phosphite stablizer (6.29 vs. 4.77), but E_{c} is almost three times smaller in Example 15 (2.67 vs. 7.97). Surprisingly, the composition with phosphite requires much less energy to cure the same depth of photocurable composition relative to the composition with no phosphite. The tensile strength and tensile modulus in Example 15 is much lower than in Example 14 without the Alkanox TNPP and the elongation to break is slightly greater. It may be possible to recover these properties through optimization of the components.

While embodiments of the invention have been described above, those embodiments illustrate but do not limit the invention. Adaptations and variations of those embodiments are within the scope of the invention as set forth in the following claims.

We claim:

1. A photocurable composition, comprising:
(a) from 40 to 80% by weight of an epoxy resin component;
(b) from 5 to 40% by weight of a (meth)acrylate component;
(c) a cationic photoinitiator;
(d) a radical photoinitiator; and
(e) a phosphite ester that is an aliphatic, aromatic, or mixed aliphatic and aromatic phosphite ester, wherein the phosphite ester has the formula (I) or (II): 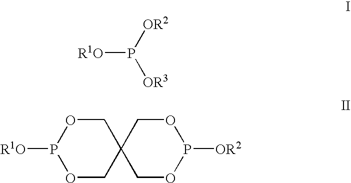
wherein:
R¹, R², and R³ are independently C4-C20 straight or branched alkyl, C4-C7 cycloalkyl, or phenyl,
the C4-C20 straight or branched alkyl is unsubstituted or substituted with one or more of C4-C7 cycloalkyl or phenyl, and
the cycloalkyl and phenyl is unsubstituted or substituted with one or more of C1-C12 straight or branched alkyl.

2. A composition as claimed in claim 1, wherein component (e) is from 0.005 to 10% by weight of the composition.

3. A composition as claimed in claim 1, wherein the phosphite ester has the formula (I) and R¹, R², and R³ are independently phenyl, C8-C10 alkyl phenyl, bis-(C3-C5)alkyl phenyl, or C8-C12 alkyl.

4. A composition as claimed in claim 3, wherein R¹, R², and R³ are independently C8-C12 alkyl or C8-C12 alkyl phenyl.

5. A composition as claimed in claim 4, wherein (e) comprises triisodecyl phosphite or tris(nonylphenyl)phosphite.

6. A composition as claimed in claim 1, wherein (e) comprises a compound of formula II, wherein R¹ and R² are independently phenyl, unsubstituted or substituted with one or more C1-C6 alkyl.

7. A composition as claimed in claim 6, wherein (e) comprises: a compound of formula II, wherein R¹ and R² are both 2,4-di(tert-butyl)phenyl.

8. A composition as claimed in claim 1, further comprising benzyl dimethyl amine (BDMA).

9. A composition as claimed in claim 1, wherein (c) comprises a sulfonium salt.

10. A composition as claimed in claim 1, wherein (a) comprises a polyepoxide.

11. A composition as claimed in claim 10, wherein (a) comprises an alicyclic polyepoxide.

12. A composition as claimed in claim 10, wherein the alicyclic polyepoxide has monomer purity of over about 94%.

13. A composition as claimed in claim 1, wherein (b) comprises a poly(meth)acrylate.

14. A composition as claimed in claim 13, wherein the poly(meth)acrylate contains at least one hydroxy group.

15. A composition as claimed in claim 13, wherein (b) comprises a di(meth)acrylate and a poly(meth)acrylate containing at least three (meth)acrylate groups.

16. A composition as claimed in claim 1, further comprising a polyether polyol.

17. A method comprising:
(1) forming a first layer of the photocurable composition of claim 1;
(2) exposing the first layer to actinic radiation sufficient to harden the first layer;
(3) forming a second layer of the photocurable composition of claim 1 above the hardened first layer;
(4) exposing the second layer to actinic radiation sufficient to harden the second layer; and
(5) repeating steps (3) and (4) as needed to form a 3-D object.

18. A method as claimed in claim 17, further comprising a step of postcuring the 3-D object.

19. A 3-D object, prepared by the method of claim 18.

20. The 3-D object of claim 19, wherein the 3-D object is water-clear.

21. The 3-D object of claim 19, wherein the 3-D object is opaque or colored.
